(19) United States
(12) Patent Application Publication
(10) Pub. No.: US 2014/0034768 A1
(43) Pub. Date: Feb. 6, 2014

(54) SHREDDER BLADE AND MANUFACTURING METHOD THEREOF

(71) Applicant: NINGBO OFITECH BUSINESS MACHINES CO., LTD, Ningbo-city (CN)

(72) Inventor: Wujun WEI, Ningbo-city (CN)

(73) Assignee: NINGBO OFITECH BUSINESS MACHINES CO., LTD, Ningbo-city (CN)

(21) Appl. No.: 13/758,300

(22) Filed: Feb. 4, 2013

Related U.S. Application Data
(63) Continuation of application No. PCT/CN2012/084864, filed on Nov. 20, 2012.

(30) Foreign Application Priority Data
Aug. 3, 2012 (CN) 201210275462.5

(51) Int. Cl. B26F 1/38; B02C 18/06

(52) U.S. Cl. CPC B26F 1/38; B02C 18/06
USPC 241/293; 29/557

(57) ABSTRACT

The present invention discloses a paper cutting blade for a paper shredder, which paper cutting blade comprises two blade single bodies abutted against each other, in which said blade single body has an outer plane perpendicular to the axis of said blade single body and an outer circumferential surface located on the outer circumference of said blade single body with the axis of said blade single body as a symmetry axis, a blade edge is formed on the conjunction of said outer plane and said outer circumferential surface; when viewing from a longitudinal section of said blade single body, said blade edge is defined by an even straight line extending outwards along the radial direction of said outer plane and an curved line extending obliquely outwards along the axial direction of said outer circumferential surface.

### CROSS-REFERENCE TO RELATED APPLICATIONS

This application claims priority under 35 U.S.C. §119 to Chinese Patent Application No. CN201210275462.5, filed Aug. 3, 2012, the entire disclosures of which are herein expressly incorporated by reference.

### TECHNICAL FIELD

The present invention relates to a paper cutting blade of a paper shredder, and also to a manufacturing method of the blade.

### BACKGROUND ART

In existing paper shredders, the cutting edges through the blades basically are all of a right angle, as shown in FIG. 1, which are formed by blanking a flat plate directly via die cutting, with an cutting edge being formed by a burred face 1′, thus the blade cutting edge is not sharp enough to completely cut-through the paper but with most of the paper being torn apart with the blade during paper shredding, resulting in a burred shape at the paper scrap margins; therefore shredding paper with such blades requires high power and produces large noise, which leading to a requirement for a large power on the motor and a good gear strength on a transmission system, and all these cause an increase in the cost of a paper shredder. Moreover, due to the torn against the paper by the blades, a large force is suffered by the inner parts of the machine with the result of the parts such as blade bar, end plate, blade ring and so on being susceptible to deform and damage under huge impact force, thus the service life of the machine can be affected.

### SUMMARY OF THE INVENTION

A first technical problem to be solved by the present invention is to provide a paper cutting blade of a paper shredder with low paper shredding power consumption and small noise, with which the paper shredding capacity of a paper shredder can be improved greatly.

A second technical problem to be solved by the present invention is to provide a manufacturing method for the above mentioned paper shredder blade, which is simple and easy in operation and is relatively low in the cost.

The technical solution employed by the present invention for solving the above mentioned first technical problem is a paper cutting blade for a paper shredder, which paper cutting blade comprises two blade single bodies abutted against each other, characterized in that said blade single body has an outer plane perpendicular to the axis of said blade single body and an outer circumferential surface located at the outer circumference of said blade single body with the axis of said blade single body as a symmetry axis, with a blade edge being formed at the conjunction of said outer plane and said outer circumferential surface; when viewing from a longitudinal cross section of said blade single body, said blade edge is defined by an even straight line extending outwards along the radial direction of said outer plane and an curved line extending obliquely outwards along the axial direction of said outer circumferential surface.

When viewing from a longitudinal cross section of said blade single body, the generatrix of said outer circumferential surface includes a straight line segment extending substantially along the axial direction, with said curved line extending obliquely outwards along the axial direction from the end of said straight line segment, so that the blade single piece can achieve the effect of scissor edges, thereby shearing paper with a relatively good paper shredding effect.

Preferably, the thickness of said blade single body is 1 mm-4 mm, the axial height of said blade edge is 0.2 mm-1.5 mm, and the radial height of said blade edge is 0.1 mm-1 mm, so that the blade edge is of a relatively good paper shredding effect.

An annular positioning groove is opened on said outer plane at the radially inner side of said blade edge; when machining a blade, in the step of bending the stamp bending can be conducted at the the positioning groove of the blade, thus ensuring that the bending positions keep to be consistent.

The outer circumference of said blade single body also has at least one cutting-off edge extending outwards from said outer circumferential surface, so that it can cut off the paper scrap strips sheared by the blade edges.

The included angle between said even straight line (111) and said curved line (122) is less than 90°. Preferably, said included angle is 45°-85°.

A technical solution employed by the present invention for solving said second technical problem is a manufacturing method for a paper cutting blade of a paper shredder, characterized by comprising the following steps:

I die cut blanking, die cut blanking a flat plate into a blade blank, and stamping on the outer plane of said blade blank perpendicular to the axis of said blade blank (2), at a position near to the periphery, to form an annular positioning groove;

II stamp bending, stamp bending said blade blank at said positioning groove so as to make the portion of said blade blank located at the outer side of said positioning groove bent at a certain angle towards the direction of said outer plane, thereby to locate it in a different plane with the portion located at the inner side of said positioning groove;

III die cutting, die cutting said blade blank vertically along the axial direction to obtain a blade blank with an outer circumferential surface being a cylindrical surface; and

IV shaping, applying an axial force to the entire blade blank at the opposite side of said positioning groove to make the bent portion obtained via die cut in the step III deformed to straighten the blade blank, thus forming a blade single body (1).

Comparing to prior art, the present invention is advantageous in that by means machining a sharp blade edge at a paper cutting periphery of the blade single body, which the blade edge is defined by the even straight line of the outer plane and the curved line of the outer circumferential surface, the blade edge is enabled to effect paper shearing, which can greatly improve the paper shredding capacity of the paper shredder, reduce the paper shredding forces, smooth the paper shredding process, reduce the paper shredding noise, decrease the machine cost, prolong the service life of the machine, and reduce the energy consumption.

### DESCRIPTION OF DRAWINGS

FIG. 1 is an schematic view of a blade cutting edge of prior art;

FIG. 2 is an schematic view of a blade of the present invention;

FIG. 3 is a partial sectional view of a blade of the present invention;

FIG. 4 is a schematic view of a blade in step I of the forming process of the present invention;

FIG. 5-1 is an schematic view of a blade in step II of the forming process of the present invention;

FIG. 5-2 is a sectional view of FIG. 5-1;

FIG. 6-1 is an schematic view of a blade in step III of the forming process of the present invention;

FIG. 6-2 is a sectional view of FIG. 6-1;

FIG. 7-1 is a sectional view of a blade in step IV of the forming process of the present invention;

FIG. 7-2 is a sectional view of a blade formed by the forming process of the present invention.

### DETAILED DESCRIPTION OF EMBODIMENTS

The present invention is further described below with reference made to the drawings and embodiments:

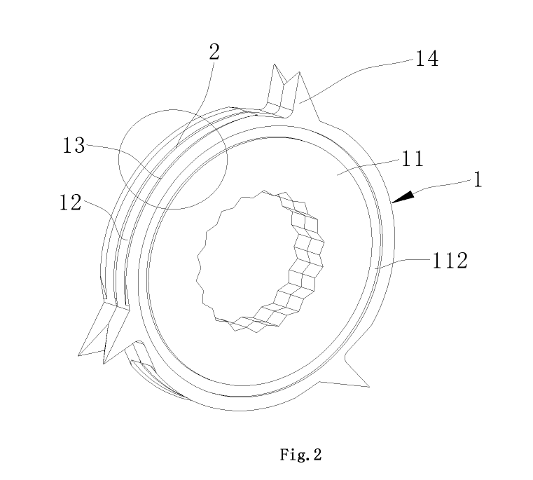

Referring to FIG. 2, a paper cutting blade for a paper shredder comprises two blade single bodies 1 abutted against each other, each of the blade single bodies 1 has an outer plane 11 perpendicular to the axis thereof and an outer circumferential surface 12 located on the outer circumference with the axis thereof as a symmetry axis, with a blade edge 13 being formed at the conjunction of the outer plane 11 and the outer circumferential surface 12.

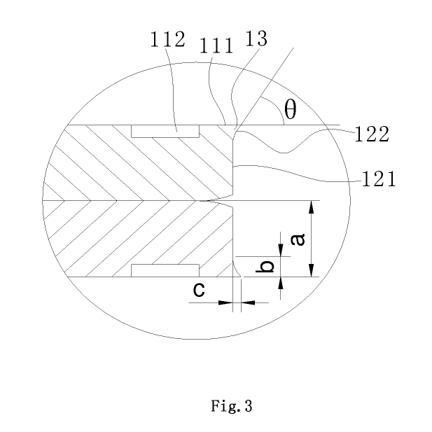

Referring to FIG. 3, a longitudinal partial section view of the two blade single bodies 1, the outer circumferential surface 12 is presenting an approximately cylindrical shape, the generatrix of the outer circumferential surface 12 includes a straight line segment 121 extending vertically along the axial direction and an curved line 122 extending outwards obliquely and along the axial direction from the end of the straight line segment 121, and the curved line 122 defines a blade edge 13 with the even straight line 111 of the outer plane 11 which is extending radially outwards. The included angle θ between said even straight line 111 and the curved line 122 is less than 90°, that is to say, a tangent line of the curved line 122 can be drawn through the tangent point between the even straight line 111 and the curved line 122, between said tangent line and the even straight line 111 it shows the included angle θ. Preferably, said included angle θ is 45°-85°. In a first embodiment, the included angle θ is 85°. In a second embodiment, the included angle θ is 80°. In a third embodiment, the included angle θ is 70°. In a fourth embodiment, the included angle θ is 60°. In a fifth embodiment, the included angle θ is 50°. In a sixth embodiment, the included angle θ is 45°. By means of said blade edge 13 presenting a certain included angle θ, the contact between the paper cutting blade and the paper to be shredded turns to a linear contact from the original plane contact, so that the paper shredding process becomes easier, and the power required is less as well, which achieves an effect of energy saving.

In this embodiment, an annular positioning groove 112 is opened with respect to the blade edge 13 on the radially inner side of the outer plane 11, so as to facilitate the machining of the blade single body 1. The outer circumference of the blade single body 1 is of at least one cutting-off edge 14 extending outwards from the outer circumferential surface 12, so that it can cut off the paper scrap strips sheared by the blade edges 13.

The outer plane herein refers to the plane of a blade single piece 1 away from the other blade single piece when assembling the paper shredder, the same below.

Among others, preferably, the thickness a of the blade single body 1 is 1 mm-4 mm, the axial height b of the blade edge 13 is 0.2 mm-1.5 mm, and the radial height c of the blade edge 13 is 0.1 mm-1 mm. As a result of the blade edge 13 of such structure, the blade single piece 1 can achieve the effect of scissor cutting edges, thereby it can shear off papers with a relatively good paper shredding effect.

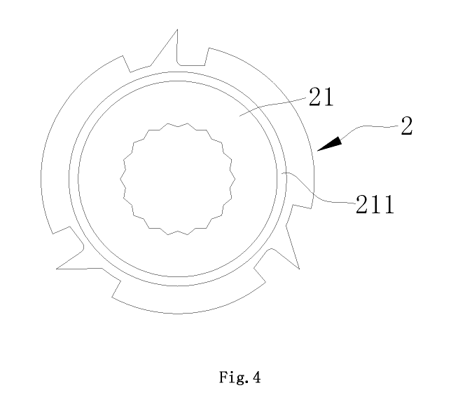

A manufacturing method for the above mentioned blade single body is as follows: step I die cut blanking, referring to FIG. 4, die cut blanking a flat plate into a blade blank 2, and then stamping on the outer plane 21 of the blade blank 2 perpendicular to the axis thereof, at a position near to the periphery, to form an annular positioning groove 211;

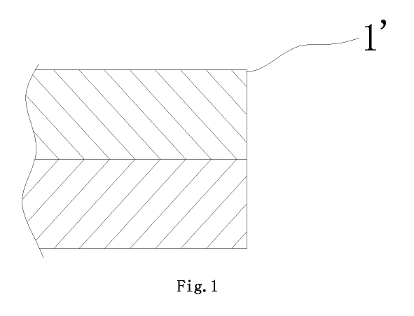

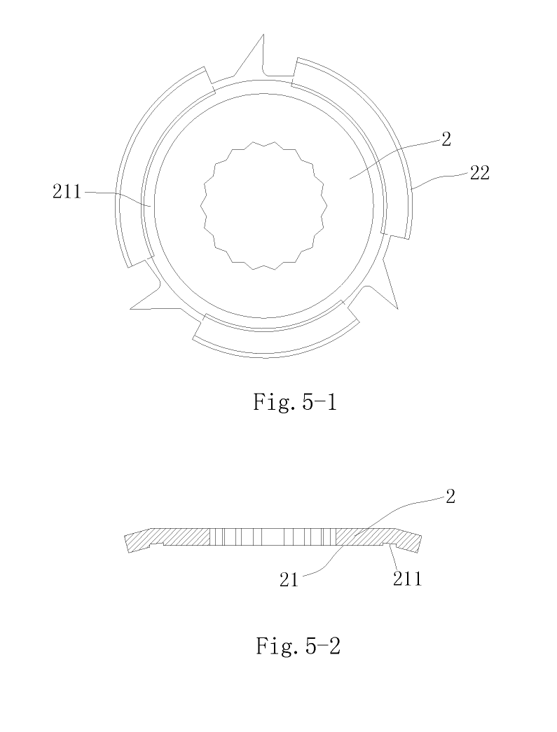

Step II stamp bending, referring to FIG. 5-1 and FIG. 5-2, stamp bending the blade blank 2 at the positioning groove 211, so as to make the portion of the blade blank 2 located at the outer side of the positioning groove 211 bent at a certain angle towards the direction of the outer plane 21, to locate it in a different plane with the portion at the inner side of the positioning groove 211;

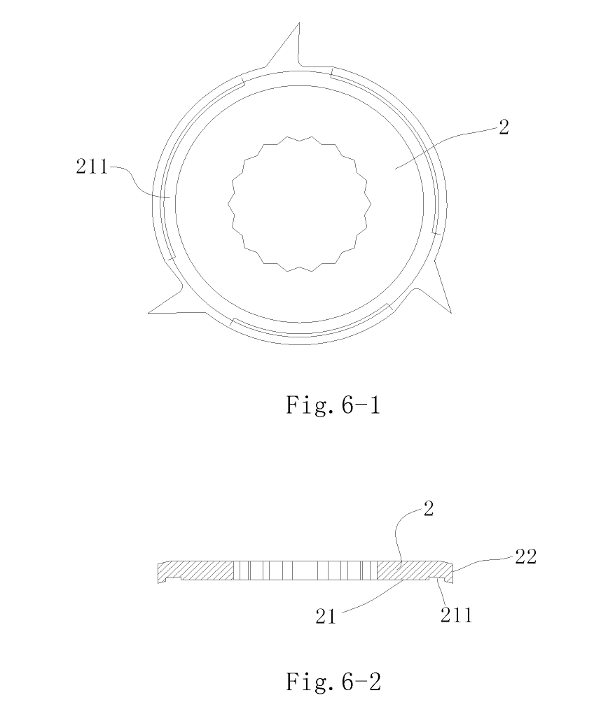

Step III die cutting, referring to FIG. 6-1 and FIG. 6-2, die cutting the outer side of the blade blank 2 vertically along the axial direction, at this time, the outer circumferential surface 22 of the blade blank 2 obtained presents a cylindrical surface;

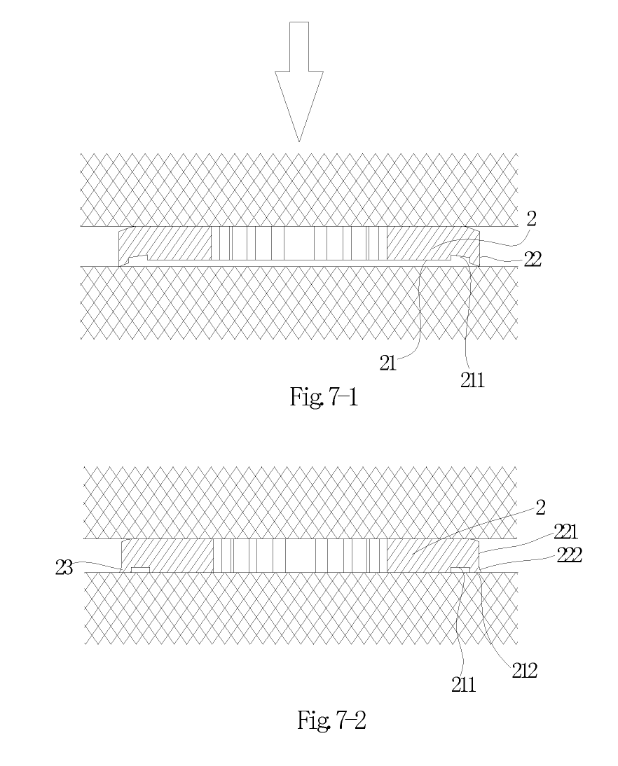

Step IV, referring to FIG. 7-1, applying an axial force to the entire blade blank 2 at the side of the blade blank 2 opposite to the positioning groove 211, to make the bent portion obtained via die cut in the step III deformed to straighten the blade blank 2; after the deformation, the generatrix of the outer circumferential surface 22 includes a straight line segment 221 extending vertically along the axial direction and a curved line 222 extending outwards obliquely and along the axial direction from the end of the straight line segment 221, with the curved line 222 and an even straight line 212 of outer plane 21 extending radially outwards define a blade edge 23, thereby a blade single body is formed, referring to FIG. 7-2.

In the paper cutting blade single body 1 manufactured in the above mentioned way, the included angle between the curved line 222 and the even straight line 212 is less than 90°. Preferably, said included angle is 45°-85°.

For those skilled in the art, various other corresponding alterations and variations can be made according to the technical solutions and conceptions described above, whereas all of these alterations and variations should still fall in the protecting scope of the claims of the present invention.

1. A paper cutting blade for a paper shredder, comprising two blade single bodies (1) abutted against each other, characterized in that said blade single body (1) has an outer plane (11) perpendicular to the axis of said blade single body (1) and an outer circumferential surface (12) located at the outer circumference of said blade single body (1) with the axis of said blade single body (1) as a symmetry axis, with a blade edge (13) being formed at the conjunction of said outer plane (11) and said outer circumferential surface (12); when viewing from a longitudinal cross section of said blade single body (1), said blade edge (13) is defined by an even straight line (111) extending outwards along the radial direction of said outer plane (11) and an curved line (122) extending obliquely outwards along the axial direction of said outer circumferential surface (12).

2. The paper cutting blade for a paper shredder according to claim 1, characterized in that when viewing from a longitudinal cross section of said blade single body (1), the generatrix of said outer circumferential surface (12) includes a straight line segment (121) extending substantially along the axial direction, with said curved line (122) extending obliquely outwards along the axial direction from the end of said straight line segment (121).

3. The paper cutting blade for a paper shredder according to claim 2, characterized in that the thickness of said blade single body (1) is 1 mm-4 mm, the axial height of said blade edge (13) is 0.2 mm-1.5 mm, and the radial height of said blade edge (13) is 0.1 mm-1 mm.

4. The paper cutting blade for a paper shredder according to claim 1, characterized in that an annular positioning groove (112) is opened on said outer plane (11) at the radially inner side of said blade edge (13).

5. The paper cutting blade for a paper shredder according to claim 1, characterized in that the outer circumference of said blade single body (1) also has at least one cutting-off edge (14) extending outwards from said outer circumferential surface (12).

6. The paper cutting blade for a paper shredder according to claim 1, characterized in that the included angle between said even straight line (111) and the curved line (122) is less than 90°.

7. The paper cutting blade for a paper shredder according to claim 6, characterized in that said included angle is 45°-85°.

8. A manufacturing method for the paper cutting blade of a paper shredder, characterized by comprising following steps:
I die cut blanking, die cut blanking a flat plate into a blade blank (2), and stamping on the outer plane (21) of said blade blank (2) perpendicular to the axis of said blade blank (2), at a position near to the periphery, to form an annular positioning groove (211);
II stamp bending, stamp bending said blade blank (2) at said positioning groove (211) so as to make the portion of said blade blank (2) located at the outer side of said positioning groove (211) bent at a certain angle towards the direction of said outer plane (21), thereby to locate it in a different plane with the portion located at the inner side of said positioning groove (211);
III die cutting, die cutting said blade blank (2) vertically along the axial direction to obtain a blade blank (2) with an outer circumferential surface (22) being a cylindrical surface;
IV shaping, applying an axial force to the entire blade blank (2) at the opposite side of said positioning groove (211) to make the bent portion obtained via die cut in the step III deformed to straighten the blade blank (2), thus forming a blade single body (1).
